(19) United States
(12) Patent Application Publication
(10) Pub. No.: US 2020/0247132 A1
(43) Pub. Date: Aug. 6, 2020

(54) AGITATION DEVICE OF INK AND PRINTING APPARATUS

(71) Applicant: RISO KAGAKU CORPORATION, Tokyo (JP)

(72) Inventors: Toshiya SAIGUSA, Ibaraki (JP); Hiroshi SUGITANI, Ibaraki (JP)

(73) Assignee: RISO KAGAKU CORPORATION, Tokyo (JP)

(21) Appl. No.: 16/732,578

(22) Filed: Jan. 2, 2020

(30) Foreign Application Priority Data
Jan. 31, 2019 (JP) 2019-015629

(51) Int. Cl. B41J 2/175

(52) U.S. Cl. CPC B41J 2/17513

(57) ABSTRACT

An agitation device includes a first agitator configured to agitate. The first agitator includes: a container configured to house the ink obtained from an ink cartridge; an agitation route being a route which is separated from the ink cartridge and through which the ink housed in the container flows out from the container and returns to the container; and a liquid deliverer configured to deliver the ink such that the ink flows out from the container and returns to the container through the agitation route.

### CROSS REFERENCE TO RELATED APPLICATION

This application is based upon and claims the benefit of priority from the prior Japanese Patent Application No. 2019-015629, filed on Jan. 31, 2019, the entire contents of which are incorporated herein by reference.

### BACKGROUND

### 1. Technical Field

The disclosure relates to an agitation device and a printing apparatus.

### 2. Related Art

Pigment ink is sometimes used in an inkjet printing apparatus. Leaving the pigment ink at rest sometimes causes sedimentation of pigment particles. The sedimentation of the pigment particles is likely to occur particularly in ink containing pigment with large specific weight such as metal particles.

The sedimentation of the pigment particles of the ink sometimes leads to ejection failure in an inkjet head due to an increase in viscosity of the ink. Moreover, the sedimentation of the pigment particles of the ink sometimes causes variation in the concentration of the ink ejected from the inkjet head.

Japanese Patent Application Publication No. 2004-9685 discloses a technique of agitating the ink to prevent the sedimentation of the pigment particles in a recording apparatus using the pigment ink. This recording apparatus agitates the ink in an ink cartridge by sucking the ink in the ink cartridge by a supply-suction pump and returning it to the ink cartridge from the supply-suction pump.

### SUMMARY

In the technique of Japanese Patent Application Publication No. 2004-9685, when the ink cartridge is removed from the apparatus, the ink agitation cannot be performed and the sedimentation of the pigment particles of the ink sometimes occurs in the apparatus.

The disclosure is directed to an agitation device and a printing apparatus which can agitate the ink even when an ink cartridge is removed.

An agitation device in accordance with some embodiments includes a first agitator configured to agitate ink. The first agitator includes: a container configured to house the ink obtained from an ink cartridge; an agitation route being a route which is separated from the ink cartridge and through which the ink housed in the container flows out from the container and returns to the container; and a liquid deliverer configured to deliver the ink such that the ink flows out from the container and returns to the container through the agitation route.

A printing apparatus in accordance with some embodiments includes the agitation device above and an inkjet head. The second agitator is configured to supply the ink supplied from the first agitator to the inkjet head while agitating the ink by circulating the ink.

According to the aforementioned configuration, the ink can be agitated even when an ink cartridge is removed.

### BRIEF DESCRIPTION OF DRAWINGS

FIG. 1 is a schematic configuration diagram of a printing apparatus according to an embodiment.

FIG. 2 is a flowchart for explaining operations of the printing apparatus.

FIG. 3 is a flowchart for explaining operations of the printing apparatus.

FIG. 4 is a flowchart for explaining operations of the printing apparatus.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

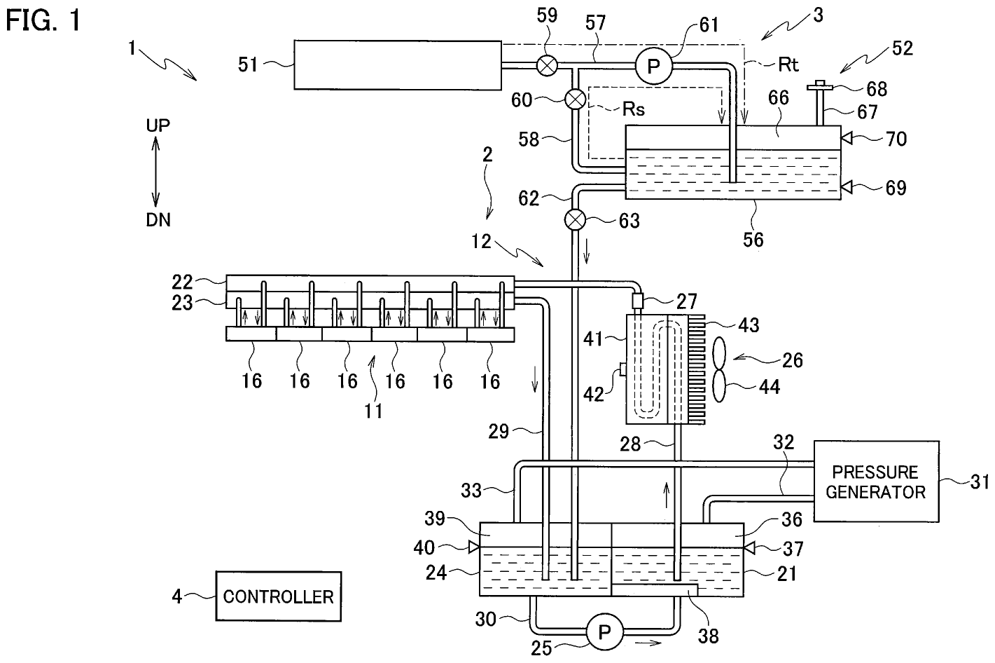

FIG. 1 is a schematic configuration diagram of a printing apparatus provided with an agitation device according to an embodiment of the present invention. Note that an up-down direction in the following description is the vertical direction and an up-down direction in the sheet surface of FIG. 1 is assumed to be the up-down direction. In FIG. 1, directions of up and down are denoted by UP and DN, respectively.

As illustrated in FIG. 1, the printing apparatus 1 according to the embodiment includes a printer 2, an ink supplier 3, and a controller 4. Note that the agitation device is formed of an agitator 52 and an ink circulator 12 to be described later.

The printer 2 prints an image on a sheet being a print medium conveyed by a not-illustrated conveyor by ejecting ink to the sheet while circulating the ink.

The ink used in the printing in the printing apparatus 1 is pigment ink and is ink in which sedimentation of pigment particles may occur when the ink is left at rest. For example, the ink used in the printing in the printing apparatus 1 is a Magnetic Ink Character Reader (MICR) ink containing metal particles which are magnetic bodies. The sedimentation of the pigment particles of the ink leads to defects such as ejection failure in an inkjet head 11 to be described later and variation in the concentration of the ejected ink. Accordingly, it is necessary to agitate the ink and prevent and eliminate the sedimentation of the pigment particles.

In the printer 2, circulation of the ink by the ink circulator 12 to be described later causes the ink supplied from the ink supplier 3 to be agitated and the sedimentation of the pigment particles is prevented and eliminated. The printer 2 includes the inkjet head 11 and the ink circulator (second agitator) 12.

The inkjet head 11 ejects the ink supplied by the ink circulator 12. The inkjet head 11 includes multiple head modules 16.

The head modules 16 include ink chambers (not illustrated) configured to store the ink and multiple nozzles (not illustrated) configured to eject the ink. Piezoelectric elements (not illustrated) are arranged in the ink chambers. The ink is ejected from the nozzles by drive of the piezoelectric elements.

The ink circulator 12 supplies the ink to the inkjet head 11 while agitating the ink by circulating the ink. The ink circulator 12 includes a positive pressurization tank 21, a distributor 22, a collector 23, a negative pressurization tank 24, an ink circulation pump 25, an ink temperature adjuster 26, an ink temperature sensor 27, ink circulation pipes 28 to 30, a pressure generator 31, a positive pressurization pressure pipe 32, and a negative pressurization pressure pipe 33.

The positive pressurization tank 21 stores the ink to be supplied to the inkjet head 11. The ink in the positive pressurization tank 21 is supplied to the inkjet head 11 via the ink circulation pipe 28 and the distributor 22. An air space 36 is formed on a liquid surface of the ink in the positive pressurization tank 21. The positive pressurization tank 21 is connected to the pressure generator 31 via the positive pressurization pressure pipe 32. The positive pressurization tank 21 is arranged at a lower position than (below) the inkjet head 11.

The positive pressurization tank 21 is provided with a positive pressurization liquid level sensor 37 and an ink filter 38. The positive pressurization liquid level sensor 37 detects whether or not the liquid level height of the ink in the positive pressurization tank 21 has reached a predetermined reference height. The positive pressurization liquid level sensor 37 outputs a signal indicating “on” when the liquid level height in the positive pressurization tank 21 is the reference height or higher and outputs a signal indicating “off” when the liquid level height is lower than the reference height. The ink filter 38 removes dusts and the like in the ink.

The distributor 22 distributes the ink, supplied from the positive pressurization tank 21 via the ink circulation pipe 28, to the head modules 16 in the inkjet head 11.

The collector 23 collects the ink, not consumed in the inkjet head 11, from the head modules 16. The ink collected by the collector 23 flows to the negative pressurization tank 24 via the ink circulation pipe 29.

The negative pressurization tank 24 receives the ink, not consumed in the inkjet head 11, from the collector 23 and stores the ink. Moreover, the negative pressurization tank 24 stores the ink supplied from the ink supplier 3. An air space 39 is formed on a liquid surface of the ink in the negative pressurization tank 24. The negative pressurization tank 24 is connected to a pressure generator 31 via the negative pressurization pressure pipe 33. The negative pressurization tank 24 is arranged at the same height as the positive pressurization tank 21.

The negative pressurization tank 24 is provided with a negative pressurization liquid level sensor 40. The negative pressurization liquid level sensor 40 detects whether or not the liquid level height of the ink in the negative pressurization tank 24 has reached a predetermined reference height. The negative pressurization liquid level sensor 40 outputs a signal indicating “on” when the liquid level height in the negative pressurization tank 24 is the reference height or higher and outputs a signal indicating “off” when the liquid level height is lower than the reference height.

The ink circulation pump 25 delivers the ink from the negative pressurization tank 24 to the positive pressurization tank 21. The ink circulation pump 25 is provided in the middle of the ink circulation pipe 30.

The ink temperature adjuster 26 adjusts the temperature of the ink in the ink circulator 12. The ink temperature adjuster 26 is provided in the middle of the ink circulation pipe 28. The ink temperature adjuster 26 includes a heater 41, a heater temperature sensor 42, a heat sink 43, and a cooling fan 44.

The heater 41 heats the ink in the ink circulation pipe 28. The heater temperature sensor 42 detects the temperature of the heater 41. The heat sink 43 cools the ink in the ink circulation pipe 28 by means of heat dissipation. The cooling fan 44 sends cooling air to the heat sink 43.

The ink temperature sensor 27 detects the temperature of the ink in the ink circulator 12. The ink temperature sensor 27 is provided in the middle of the ink circulation pipe 28.

The ink circulation pipe 28 connects the positive pressurization tank 21 and the distributor 22. The ink circulation pipe 29 connects the collector 23 and the negative pressurization tank 24. The ink circulation pipe 30 connects the negative pressurization tank 24 and the positive pressurization tank 21. The ink circulation pipes 28 to 30, the positive pressurization tank 21, the distributor 22, the collector 23, and the negative pressurization tank 24 form a circulation route through which the ink is supplied to the inkjet head 11 while being agitated by being circulated.

The pressure generator 31 generates pressure for the ink circulation in the positive pressurization tank 21 and the negative pressurization tank 24. Specifically, the pressure generator 31 sucks in air from the negative pressurization tank 24 via the negative pressurization pressure pipe 33 and sends air to the positive pressurization tank 21 via the positive pressurization pressure pipe 32 to generate positive pressure in the positive pressurization tank 21 and negative pressure in the negative pressurization tank 24.

The positive pressurization pressure pipe 32 connects the pressure generator 31 and the air space 36 of the positive pressurization tank 21. The negative pressurization pressure pipe 33 connects the pressure generator 31 and the air space 39 of the negative pressurization tank 24.

The ink supplier 3 agitates the ink and supplies the ink to the printer 2. The ink is agitated to prevent and eliminate the sedimentation of the pigment particles of the ink. The ink supplier 3 includes an ink cartridge 51 and the agitator (first agitator) 52.

The ink cartridge 51 houses the pigment ink which is the ink to be used for printing by the printer 2. The ink cartridge 51 is configured to be detachably attached to the printing apparatus 1.

The agitator 52 obtains the ink from the ink cartridge 51 and agitates the obtained ink. Moreover, the agitator 52 supplies the agitated ink to the printer 2. The agitator 52 includes an agitation tank (container) 56, an ink transfer pipe 57, an ink flow-out pipe 58, an ink transfer valve 59, an agitation valve 60, an agitation pump (liquid deliverer) 61, an ink supply pipe 62, and an ink supply valve 63.

The agitation tank 56 houses the ink obtained from the ink cartridge 51 for agitation. An air space 66 is formed on the liquid surface of the ink in the agitation tank 56. The agitation tank 56 is arranged at a higher position than (above) the positive pressurization tank 21 and the negative pressurization tank 24.

The agitation tank 56 is provided with an atmosphere opening pipe 67. One end of the atmosphere opening pipe 67 is connected to the air space 66 and the other end (upper end) communicates with the atmosphere via an air filter 68. The agitation tank 56 is thereby opened to the atmosphere. The air filter 68 prevents dust and the like in the air from entering the agitation tank 56.

Moreover, the agitation tank 56 is provided with an agitation tank lower limit sensor 69 and an agitation tank overflow sensor 70.

The agitation tank lower limit sensor 69 detects whether or not the liquid level height of the ink in the agitation tank 56 has reached a predetermined lower limit height. The agitation tank lower limit sensor 69 outputs a signal indicating “on” when the liquid level height in the agitation tank 56 is the lower limit height or higher and outputs a signal indicating “off” when the liquid level height is lower than the lower limit height. The agitation tank lower limit sensor 69 is used to determine whether or not the ink is to be transferred from the ink cartridge 51 to the agitation tank 56.

The agitation tank overflow sensor 70 detects whether or not the liquid level height of the ink in the agitation tank 56 has reached a predetermined upper limit height higher than the lower limit height. The agitation tank overflow sensor 70 outputs a signal indicating “on” when the liquid level height in the agitation tank 56 is the upper limit height or higher and outputs a signal indicating “off” when the liquid level height is lower than the upper limit height. The agitation tank overflow sensor 70 is a sensor for detecting overflow of the ink in the agitation tank 56 which may occur for some reason.

The ink transfer pipe 57 connects the ink cartridge 51 and the agitation tank 56. The ink transfer pipe 57 forms a transfer route Rt which is a route for transferring the ink from the ink cartridge 51 to the agitation tank 56.

The transfer route Rt includes a portion which is shared with an agitation route Rs to be described later. Specifically, a portion of the ink transfer pipe 57 on the agitation tank 56 side of a connection portion with the ink flow-out pipe 58 is a portion shared by the transfer route Rt and the agitation route Rs.

The ink flow-out pipe 58 connects the agitation tank 56 and the ink transfer pipe 57.

The agitation route Rs is formed of the ink flow-out pipe 58 and the portion of the ink transfer pipe 57 on the agitation tank 56 side of the connection portion with the ink flow-out pipe 58. The agitation route Rs is a route which is separated from the ink cartridge 51 and through which the ink flows out from the agitation tank 56 and returns to the agitation tank 56.

The ink transfer valve 59 opens and closes a flow path of the ink in the ink transfer pipe 57. The ink transfer valve 59 is arranged in a portion of the ink transfer pipe 57 on the ink cartridge 51 side of the connection portion with the ink flow-out pipe 58.

The agitation valve 60 opens and closes a flow path of the ink in the ink flow-out pipe 58.

The ink transfer valve 59 and the agitation valve 60 forms a switch which switches the route to be opened between the transfer route Rt and the agitation route Rs. Specifically, opening the ink transfer valve 59 and closing the agitation valve 60 sets the transfer route Rt to an open state and sets the agitation route Rs to a closed state. Moreover, closing the ink transfer valve 59 and opening the agitation valve 60 sets the agitation route Rs to an open state and sets the transfer route Rt to a closed state.

The agitation pump 61 agitates the ink in the agitation tank 56 by delivering the ink such that the ink flows out from the agitation tank 56 and returns to the agitation tank 56 through the agitation route Rs. Moreover, the agitation pump 61 is used to transfer the ink from the ink cartridge 51 to the agitation tank 56. The agitation pump 61 is arranged in the portion shared by the transfer route Rt and the agitation route Rs. Specifically, the agitation pump 61 is arranged in the portion of the ink transfer pipe 57 on the agitation tank 56 side of the connection portion with the ink flow-out pipe 58.

The ink supply pipe 62 connects the agitation tank 56 and the negative pressurization tank 24.

The ink supply valve 63 opens and closes a flow path of the ink in the ink supply pipe 62. When the ink supply valve 63 is opened, the ink is supplied from the agitation tank 56 to the negative pressurization tank 24 due to the head difference between the agitation tank 56 and the negative pressurization tank 24.

The controller 4 controls operations of the units in the printing apparatus 1. The controller 4 includes a CPU, a RAM, a ROM, a hard disk drive, and the like.

Next, operations of the printing apparatus 1 are described.

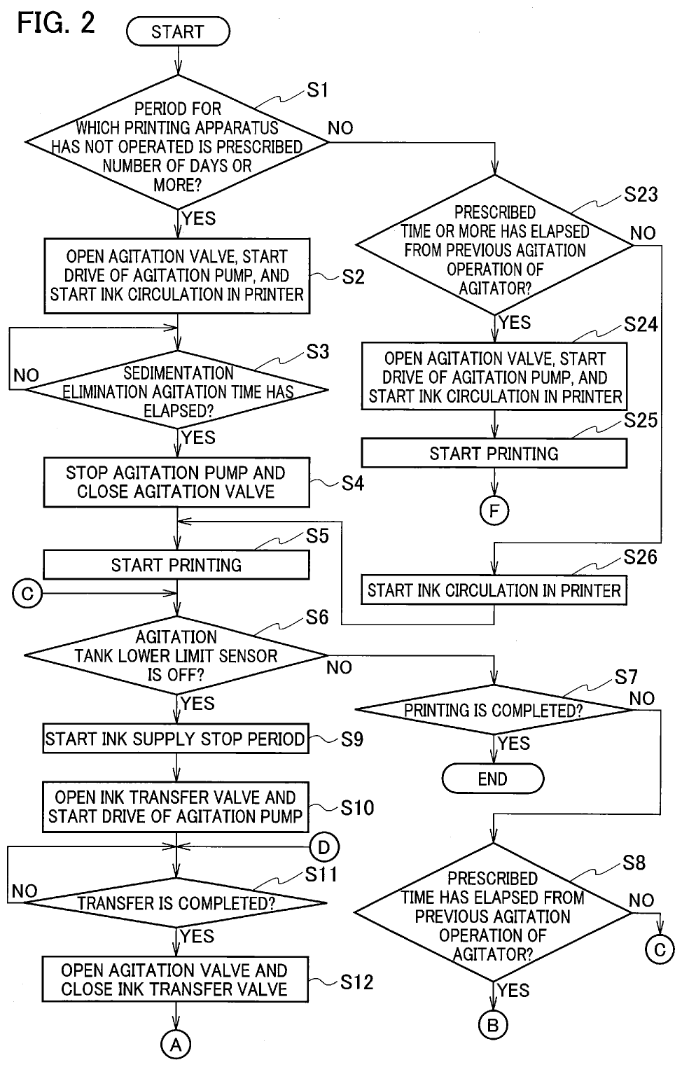

FIGS. 2 to 4 are flowcharts for explaining the operations of the printing apparatus 1. The processing of the flowcharts of FIGS. 2 to 4 starts when print start is instructed. The print start is instructed, for example, when a print job is transmitted from an external apparatus such as a personal computer to the printing apparatus 1.

In step S1 of FIG. 2, the controller 4 determines whether or not a period for which the printing apparatus 1 has not operated, that is a period from the end of the previous print operation to now is a prescribed number of days or more. In this case, the prescribed number of days is the number set in advance as a threshold for determining whether or not the agitation operation for eliminating the sedimentation of the pigment particles of the ink is to be performed. The number of prescribed days is set depending on the length of a period in which the sedimentation of the pigment particles is expected to occur if the ink is left at rest.

When the controller 4 determines that the period for which the printing apparatus 1 has not operated is the prescribed number of days or more (step S1: YES), in step S2, the controller 4 opens the agitation valve 60 and starts the drive of the agitation pump 61. In this case, the ink transfer valve 59 is closed.

Opening the agitation valve 60 with the ink transfer valve 59 closed sets the transfer route Rt to the closed state and sets the agitation route Rs to the open state. Driving the agitation pump 61 in this state circulates the ink along the agitation route Rs and the ink in the agitation tank 56 is agitated. The agitation operation of the ink in the agitator 52 is thus performed.

Moreover, in step S2, the controller 4 starts the ink circulation in the printer 2. Specifically, the controller 4 causes the pressure generator 31 to generate positive pressure and negative pressure for ink circulation respectively in the positive pressurization tank 21 and the negative pressurization tank 24. The ink thereby flows from the positive pressurization tank 21 to the negative pressurization tank 24 via the inkjet head 11.

When the positive pressurization liquid level sensor 37 is off and the negative pressurization liquid level sensor 40 is on, the controller 4 drives the ink circulation pump 25. The ink is thereby delivered from the negative pressurization tank 24 to the positive pressurization tank 21. When the positive pressurization liquid level sensor 37 turns on, the controller 4 stops the ink circulation pump 25.

The ink is thus circulated along the circulation route of the ink circulator 12 and is agitated. This ink circulation operation is performed as the agitation operation of the ink in the printer 2. Note that the ink ejection by the inkjet head 11 is not performed in this case.

Next, in step S3, the controller 4 determines whether or not predetermined sedimentation elimination agitation time has elapsed from the start of the agitation operation of the ink in the agitator 52 and the printer 2 in step S2.

Here, the agitation operation of the ink in the agitator 52 and the printer 2 started in step S2 is an operation for eliminating the sedimentation of the pigment particles which has occurred due to leaving of the ink in the printing apparatus 1 for a long period. The sedimentation elimination agitation time is set in advance as duration of the agitation operation for eliminating the sedimentation of the pigment particles. When the controller 4 determines that the sedimentation elimination agitation time has not elapsed yet (step S3: NO), the controller 4 repeats step S3.

When the controller 4 determines that the sedimentation elimination agitation time has elapsed (step S3: YES), in step S4, the controller 4 stops the agitation pump 61 and closes the agitation valve 60. The agitation operation of the ink in the agitator 52 is thereby completed.

Next, in step S5, the controller 4 starts the printing by the printer 2. Specifically, the controller 4 drives the head modules 16 of the inkjet head 11 and causes the head modules 16 to eject the ink based on image data to be printed.

Note that the ink circulation operation by the ink circulator 12 is continuously performed after the start of the printing in the printer 2. The agitation operation of the ink is thus performed in the printing in the printer 2 and this prevents the sedimentation of the pigment particles of the ink. When the printing based on the image data to be printed is completed after the printing start, the controller 4 terminates the ink circulation operation by the ink circulator 12.

Moreover, in the printing, when the ejection of the ink from the inkjet head 11 causes the ink amount in the printer 2 to decrease and the positive pressurization liquid level sensor 37 and the negative pressurization liquid level sensor 40 both turn off, the controller 4 opens the ink supply valve 63. The ink is thereby supplied from the agitation tank 56 to the negative pressurization tank 24. When the negative pressurization liquid level sensor 40 turns on, the controller 4 closes the ink supply valve 63. Supplying the ink from the agitation tank 56 to the negative pressurization tank 24 as described above causes the ink in the agitation tank 56 to decrease. When the ink in the agitation tank 56 decreases to a point where the agitation tank lower limit sensor 69 turns off, the ink needs to be resupplied from the ink cartridge 51 to the agitation tank 56.

Accordingly, after the printing start, in step S6, the controller 4 determines whether or not the agitation tank lower limit sensor 69 is off.

When the controller 4 determines that the agitation tank lower limit sensor 69 is on (step S6: NO), in step S7, the controller 4 determines whether or not the printing based on the image data to be printed is completed. When the controller 4 determines that the printing is completed, the controller 4 terminates the ink circulation operation by the ink circulator 12 and terminates the series of operations.

When the controller 4 determines that the printing is not completed (step S7: NO), in step S8, the controller 4 determines whether or not prescribed time has elapsed from the previous agitation operation of the agitator 52.

The prescribed time is time set in advance as an interval for performing a regular agitation operation of the agitator 52. The regular agitation operation of the agitator 52 is performed to prevent the sedimentation of the pigment particles of the ink in the agitation tank 56.

When the controller 4 determines that the prescribed time has not elapsed from the previous agitation operation of the agitator 52 (step S8: NO), the controller 4 returns to step S6. In this case, the previous agitation operation of the agitator 52 include the regular agitation operation, the aforementioned agitation operation for eliminating the sedimentation of the pigment particles which has occurred due to leaving of the ink in the printing apparatus 1 for a long period, and an initial agitation operation to be describe later.

In step S6, when the controller 4 determines that the agitation tank lower limit sensor 69 is off (step S6: YES), in step S9, the controller 4 starts an ink supply stop period. The ink supply stop period is a period in which the supply of the ink from the agitation tank 56 to the printer 2 is stopped. In the ink supply stop period, the ink supply valve 63 is not opened even if the positive pressurization liquid level sensor 37 and the negative pressurization liquid level sensor 40 are both off.

The ink supply stop period is provided to avoid the case where air is sent from the agitation tank 56 with a low ink remaining amount to the negative pressurization tank 24 and is thereby mixed into the ink in the printer 2. Moreover, the ink supply stop period is provided to avoid the case where the ink transferred from the ink cartridge 51 to the agitation tank 56 is supplied to the printer 2 without being sufficiently agitated. Note that the positive pressurization tank 21 and the negative pressurization tank 24 have capacities capable of continuing the printing during the ink supply stop period.

Next, in step S10, the controller 4 opens the ink transfer valve 59 and starts the drive of the agitation pump 61. In this case, the agitation valve 60 is closed. Opening the ink transfer valve 59 with the agitation valve 60 closed sets the agitation route Rs to the closed state and sets the transfer route Rt to the open state. Driving the agitation pump 61 in this state causes the ink to be transferred from the ink cartridge 51 to the agitation tank 56 along the transfer route Rt. In this case, a new ink cartridge 51 is attached to the printing apparatus 1.

Next, in step S11, the controller 4 determines whether or not the transfer of the ink from the ink cartridge 51 to the agitation tank 56 is completed. In this case, the controller 4 can determine whether or not the transfer of the ink is completed based on, for example, time elapsed from the start of the drive of the agitation pump 61. When the controller 4 determines that the transfer of the ink is not completed (step S11: NO), the controller 4 repeats step S11.

When the controller 4 determines that the transfer of the ink is completed (step S11: YES), in step S12, the controller 4 closes the ink transfer valve 59 and opens the agitation valve 60. This sets the agitation route Rs to the open state and sets the transfer route Rt to the closed state and there is started the initial agitation operation which is an agitation operation of the agitator 52 for agitating the ink newly introduced from the ink cartridge 51 into the agitation tank 56. The ink is agitated by this initial agitation operation because there may be the sedimentation of the pigment particles of the ink in the ink cartridge 51.

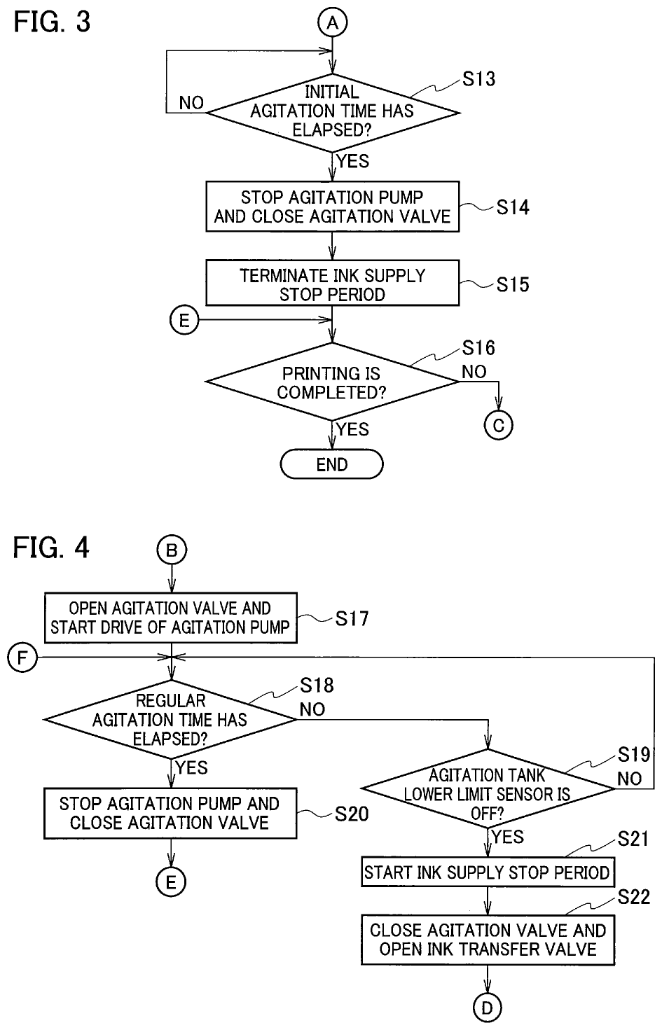

Next, in step S13 of FIG. 3, the controller 4 determines whether or not predetermined initial agitation time has elapsed from the opening of the agitation valve 60 in step S12. The initial agitation time is time set in advance as time for sufficiently agitating the ink newly introduced from the ink cartridge 51 into the agitation tank 56. When the controller 4 determines that the initial agitation time has not elapsed (step S13: NO), the controller 4 repeats step S13.

When the controller 4 determines that the initial agitation time has elapsed (step S13: YES), in step S14, the controller 4 stops the agitation pump 61 and closes the agitation valve 60. The initial agitation operation is thereby completed.

Next, in step S15, the controller 4 terminates the ink supply stop period. When the positive pressurization liquid level sensor 37 and the negative pressurization liquid level sensor 40 both turns off after this termination, the controller 4 opens the ink supply valve 63.

Note that the ink supply stop period may be terminated before the completion of the initial agitation operation. Specifically, the supply of the ink from the agitation tank 56 to the printer 2 may be enabled during the initial agitation operation when the ink is agitated to a level at which the ink can be ejected from the inkjet head 11 without trouble.

Next, in step S16, the controller 4 determines whether or not the printing based on the image data to be printed is completed. When the controller 4 determines that the printing is completed (step S16: YES), the series of operations is terminated. When the controller 4 determines that the printing is not completed (step S16: NO), the controller 4 returns to step S6 of FIG. 2.

In step S8 of FIG. 2, when the controller 4 determines that the prescribed time has elapsed from the previous agitation operation of the agitator 52 (step S8: YES), in step S17 of FIG. 4, the controller 4 opens the agitation valve 60 and starts the drive of the agitation pump 61. The regular agitation operation of the agitator 52 is thereby started.

Next, in step S18, the controller 4 determines whether or not a predetermined regular agitation time has elapsed from the start of the drive of the agitation pump 61 in step S17. The regular agitation time is set in advance as time of the agitation operation for preventing the sedimentation of the pigment particles of the ink in the agitation tank 56.

When the controller 4 determines that the regular agitation time has not elapsed yet (step S18: NO), in step S19, the controller 4 determines whether or not the agitation tank lower limit sensor 69 is off. When the controller 4 determines that the agitation tank lower limit sensor 69 is on (step S19: NO), the controller 4 returns to step S18.

When the controller 4 determines that the regular agitation time has elapsed in step S18 (step S18: YES), in step S20, the controller 4 stops the agitation pump 61 and closes the agitation valve 60. The regular agitation operation of the agitator 52 is thereby terminated. Thereafter, the controller 4 proceeds to step S16 of FIG. 3 and executes the processing of step S16 and beyond.

When the controller 4 determines that the agitation tank lower limit sensor 69 is off in step S19 of FIG. 4 (step S19: YES), in step S21, the controller 4 starts the ink supply stop period.

Next, in step S22, the controller 4 closes the agitation valve 60 and opens the ink transfer valve 59. This switches the agitation route Rs to the closed state and the transfer route Rt to the open state and the ink starts to be transferred from the ink cartridge 51 to the agitation tank 56 along the transfer route Rt. In this case, a new ink cartridge 51 is attached to the printing apparatus 1. Thereafter, the controller 4 proceeds to step S11 of FIG. 2 and executes the processing of step S11 and beyond.

When the controller 4 determines that the period for which the printing apparatus 1 has not operated is less than the prescribed number of days in step S1 of FIG. 2 (step S1: NO), in step S23, the controller 4 determines whether or not prescribed time or more has elapsed from the previous agitation operation of the agitator 52.

In this case, in the printing apparatus 1, the regular agitation operation of the agitator 52 is performed every prescribed time as described above. However, if the printing apparatus 1 is in a sleep mode or a power off state at the moment when the prescribed time elapses from the previous agitation operation of the agitator 52, the agitation operation of the agitator 52 is not performed at this timing. Meanwhile, if the prescribed time or more has elapsed from the previous agitation operation of the agitator 52 and the period for which the printing apparatus 1 has not operated is less than the prescribed number of days at the moment when the printing apparatus 1 returns to the normal mode in response to the print start instruction given in the sleep mode or when the first print start instruction after the power on is executed, the agitation operation of the agitator 52 is performed before the start of the print operation.

Thus, when the controller 4 determines that the prescribed time or more has elapsed from the previous agitation operation of the agitator 52 (step S23: YES), in step S24, the controller 4 opens the agitation valve 60 and starts the drive of the agitation pump 61. In this case, the ink transfer valve 59 is closed. The agitation operation of the ink in the agitator 52 is thereby performed. Moreover, in step S24, the controller 4 starts the ink circulation in the printer 2.

Then, in step S25, the controller 4 starts the printing by the printer 2. Thereafter, the controller 4 proceeds to step S18 of FIG. 4 and executes the processing of S18 and beyond.

When the controller 4 determines that the prescribed time or more has not elapsed from the previous agitation operation of the agitator 52 in step S23 of FIG. 2 (step S23: NO), in step S26, the controller 4 starts the ink circulation in the printer 2. Thereafter, the controller 4 proceeds to step S5 and executes the processing of S5 and beyond.

As described above, the printing apparatus 1 includes the agitator 52 which includes the agitation tank 56 configured to store the ink obtained from the ink cartridge 51, the agitation route Rs separated from the ink cartridge 51, and the agitation pump 61 configured to agitate the ink in the agitation tank 56 by delivering the ink through the agitation route Rs. Since the ink obtained from the ink cartridge 51 is agitated in the agitator 52, the ink can be agitated in the printing apparatus 1 even when the ink cartridge 51 is removed.

Accordingly, the user can replace the ink cartridge 51 at any timing after the completion of the transfer of the ink from the ink cartridge 51 to the agitation tank 56 and the usability is thus improved.

Moreover, in the printing apparatus 1, the agitation pump 61 is disposed in the portion shared by the transfer route Rt and the agitation route Rs. The agitation pump 61 is used to agitate the ink in the agitation tank 56 by using the agitation route Rs when the agitation route Rs is open and to transfer the ink from the ink cartridge 51 to the agitation tank 56 when the transfer route Rt is open. The agitation of the ink in the agitation tank 56 and the transfer of the ink from the ink cartridge 51 to the agitation tank 56 are thereby performed by using one agitation pump 61. Thus, it is possible to suppress increases in the size and complexity of the apparatus configuration.

Moreover, in the printing apparatus 1, the ink supplied from the agitator 52 is agitated in the ink circulator 12 of the printer 2 in printing. Agitating the ink also in the ink circulator 12 as described above can reduce defects such as ejection failure of the ink which may occur due to the sedimentation of the pigment particles.

Specifically, the ink circulator 12 supplies the ink to the inkjet head 11 while agitating the ink by circulating the ink. The ink is thereby agitated by using the circulation route of the ink circulator 12 for supplying the ink to the inkjet head 11. Thus, the ink agitated in the agitator 52 can be further agitated without addition of a dedicated mechanism.

Note that, although the configuration in the aforementioned embodiment is such that the agitation of the ink in the agitation tank 56 and the transfer of the ink from the ink cartridge 51 to the agitation tank 56 are performed by using one agitation pump 61, the configuration may be such that these operations are performed by using different pumps. Moreover, the transfer of the ink from the ink cartridge 51 to the agitation tank 56 is not limited to the transfer using the pump and may be, for example, transfer using the head difference between the ink cartridge 51 and the agitation tank 56.

Moreover, although the configuration in the aforementioned embodiment is such that the ink is supplied from the agitation tank 56 to the negative pressurization tank 24 by using the head difference between the agitation tank 56 and the negative pressurization tank 24, the ink may be supplied from the agitation tank 56 to the negative pressurization tank 24 by using a pump or the like.

Furthermore, in the aforementioned embodiment, the configuration is such that the ink is supplied from the positive pressurization tank 21 to the inkjet head 11 and is returned from the inkjet head 11 to the negative pressurization tank 24 by using pressure. However, the configuration for supplying the ink from the ink tank upstream of the inkjet head to the inkjet head and returning the ink from the inkjet head to the ink tank downstream of the inkjet head is not limited to this. For example, the ink can be supplied from the ink tank upstream of the inkjet head to the inkjet head and returned from the inkjet head to the ink tank downstream of the inkjet head by using a pump.

Moreover, although the case where the printer 2 is an ink circulation type inkjet printer is described in the aforementioned embodiment, the configuration of the printer is not limited to this. For example, the printer 2 may be a printer which includes an inkjet head and which is not the ink circulation type printer, the printer including an agitation mechanism (second agitator) configured to agitate the ink supplied from the agitator 52 and supply the ink to the inkjet head.

Furthermore, although description is given of the printing apparatus 1 including the agitator 52 and the ink circulator 12 as the mechanisms configured to agitate the ink in the aforementioned embodiment, the printing apparatus 1 may include only the agitator 52 as the ink agitation mechanism.

Moreover, although the agitation tank 56 is described as the container configured to house the ink in the agitator 52 in the aforementioned embodiment, the configuration of the container of the agitator 52 is not limited to this. For example, the container may be a flexible pack.

Furthermore, although the case where the ink in which the sedimentation of the pigment particles occurs is agitated is described in the aforementioned embodiment, the ink to be agitated is not limited to the ink in which the sedimentation of the contents occurs. For example, the ink to be agitated may be ink in which separation of contents occurs.

Embodiments of the disclosure include, for example, the following configuration.

An agitation device includes a first agitator configured to agitate. The first agitator includes: a container configured to house the ink obtained from an ink cartridge; an agitation route being a route which is separated from the ink cartridge and through which the ink housed in the container flows out from the container and returns to the container; and a liquid deliverer configured to deliver the ink such that the ink flows out from the container and returns to the container through the agitation route.

The first agitator may further include: a transfer route being a route through which the ink is transferred from the ink cartridge to the container and which includes a portion shared with the agitation route; and a switch configured to switch a route to be opened between the transfer route and the agitation route. The liquid deliverer may be arranged in the portion shared by the transfer route and the agitation route, configured to deliver the ink such that the ink flows out from the container and returns to the container through the agitation route with the agitation route opened by the switch, and configured to deliver the ink from the ink cartridge to the container with the transfer route opened by the switch.

The agitation device may further include a second agitator configured to agitate the ink supplied from the first agitator in printing.

A printing apparatus includes: the agitation device above and an inkjet head. The second agitator is configured to supply the ink supplied from the first agitator to the inkjet head while agitating the ink by circulating the ink.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. An agitation device comprising
a first agitator configured to agitate ink,
wherein the first agitator comprises:
a container configured to house the ink obtained from an ink cartridge;
an agitation route being a route which is separated from the ink cartridge and through which the ink housed in the container flows out from the container and returns to the container; and
a liquid deliverer configured to deliver the ink such that the ink flows out from the container and returns to the container through the agitation route.

2. The agitation device according to claim 1, wherein
the first agitator further comprises:
a transfer route being a route through which the ink is transferred from the ink cartridge to the container and which includes a portion shared with the agitation route; and
a switch configured to switch a route to be opened between the transfer route and the agitation route, and
the liquid deliverer is
arranged in the portion shared by the transfer route and the agitation route,
configured to deliver the ink such that the ink flows out from the container and returns to the container through the agitation route with the agitation route opened by the switch, and
configured to deliver the ink from the ink cartridge to the container with the transfer route opened by the switch.

3. The agitation device according to claim 1, further comprising a second agitator configured to agitate the ink supplied from the first agitator in printing.

4. The agitation device according to claim 2, further comprising a second agitator configured to agitate the ink supplied from the first agitator in printing.

5. A printing apparatus comprising:
the agitation device according to claim 3; and
an inkjet head,
wherein the second agitator is configured to supply the ink supplied from the first agitator to the inkjet head while agitating the ink by circulating the ink.

6. A printing apparatus comprising:
the agitation device according to claim 4; and
an inkjet head,
wherein the second agitator is configured to supply the ink supplied from the first agitator to the inkjet head while agitating the ink by circulating the ink.
